(19) United States
(12) Patent Application Publication
(10) Pub. No.: US 2016/0080220 A1
(43) Pub. Date: Mar. 17, 2016

(54) APPARATUS TO INDICATE TO A USER WHEN A VOIP COMMUNICATION SESSION IS ACTIVELY ESTABLISHED

(71) Applicant: Procinctu Group, Inc., Fort Mill, SC (US)

(72) Inventor: James Matthew Winningham, Cookeville, TN (US)

(21) Appl. No.: 14/851,427

(22) Filed: Sep. 11, 2015

Related U.S. Application Data
(60) Provisional application No. 62/049,807, filed on Sep. 12, 2014.

(51) Int. Cl. H04L 12/26; H04W 12/02; H04L 29/06; H04M 7/00

(52) U.S. Cl. CPC H04L 43/04; H04M 7/006; H04W 12/02; H04L 63/1408

(57) ABSTRACT

A Voice over Internet Protocol (VoIP) detecting apparatus for detecting unintended VoIP traffic between a VoIP device and a VoIP network includes an interface configured to couple between the device and the VoIP network, a receiver configured to sense packets on the VoIP network, an indicator, and a processor coupled to a memory device. The processor is configured to receive a plurality of packets sensed by the receiver, determine a packet type for each of the plurality of packets sensed by the receiver, determine the presence of VoIP traffic based on the determined packet types, and activate the indicator based on the determination of the presence of VoIP traffic.

### CROSS-REFERENCE TO RELATED APPLICATIONS

This patent application claims the benefit of U.S. Provisional Patent Application No. 62/049,807, filed Sep. 12, 2014, the entirety of which is incorporated herein by reference.

### BACKGROUND

The field of the disclosure relates generally to routing data within a global network and, more specifically, to methods and apparatus for providing vulnerability protection in Voice over Internet Protocol (VoIP) networks.

VoIP uses standardized protocols to initiate calls and to transmit audio communications across the internet. More particularly, VoIP uses a standardized call control protocol to establish the connection such as SIP (Session Initiation Protocol) and a standardized transport layer protocol such as RTP (Real-Time Protocol) to manage calls and data. Because of its demonstrated efficiencies and potential for productivity improvements, VoIP is quickly becoming the standard in private branch exchange (PBX) phone systems, whether as green-field deployment, or as an upgrade to existing networks that control routing and switching of calls between, for example, a business location and a telephone network. PBX systems using VoIP are common in many major corporations and government buildings.

As the popularity of VoIP communications has improved, internal and external threats to secure data networks has also increased. For example, VoIP deployment is currently available over WiFi when available, and cellular elsewhere. One VoIP call control standard is the Session Initiation Protocol (SIP). In addition to SIP-based desk phones, SIP-based soft-phones are being incorporated into personal computers (“PCs”), Laptops, personal data assistants (“PDAs”), and Smart-phones (IMS), for example. In voice networks, internal and external threats may have significantly amplified impacts because the telephone and its related services are personal, real-time, and interactive. All of these VoIP communications systems are vulnerable to inappropriate VoIP signaling and/or media streams that can attack an individual or an entire enterprise.

Current security management products for VoIP, although necessary and effective for what they do, cannot provide the needed functionality to stop such VoIP specific attacks. Due to security reasons, there is a concern in the marketplace that a VoIP device could become misused by an entity that gains access to the device through means of the network or through physical manipulation. Once access is gained, then the VoIP device can be inappropriately used to transport audio through the network without the knowledge of the user. As such, there exists a need for a system, method, and apparatus that provides security in VoIP communication systems (e.g., SIP, unified managed account (UMA), etc.) and that is capable of preventing the unauthorized use of the VoIP network, protecting the privacy of the VoIP users, and protecting the VoIP network infrastructure assets.

### SUMMARY

In one aspect, an apparatus for use with a Voice over Internet Protocol (VoIP) device is provided. The apparatus includes an interface, a receiver, an indicator, and a processor. The interface is configured to couple between the device and a VoIP network. The receiver is configured to sense packets on the VoIP network. The processor is coupled to a memory device, and is programmed to receive a plurality of packets sensed by the receiver, and to determine a packet type for each of the plurality of packets sensed by the receiver. The processor is further programmed to determine the presence of VoIP traffic based on the determined packet types, and to activate said indicator based on the determination of the presence of VoIP traffic.

In another aspect, a non-transitory computer readable medium for use in protecting one or more communications devices coupled to a VoIP network is provided. The computer readable medium includes program instructions when executed by a processor that causes the processor to: receive a plurality of packets sensed by a receiver configured to sense packets on the network; determine a packet type for each of the plurality of packets sensed by the receiver; determine the presence of VoIP traffic based on the determined packet types; and alert a user based on the determination of the presence of VoIP traffic.

In a further aspect, a system for protecting one or more communications devices is provided. The system includes a network communicatively coupled to the one or more communications devices, and an apparatus for use in detecting when a VoIP communication session is actively established via the network. The apparatus includes: an interface, a receiver, and a processor. The interface is coupled between the apparatus and the network. The receiver is configured to sense packets on the network. The processor is programmed to receive a plurality of packets sensed by the receiver, to determine a packet type for each of the plurality of packets sensed by the receiver, to determine the presence of VoIP traffic based on the determined packet types, and to provide an indication of the presence of VoIP traffic on the network.

### BRIEF DESCRIPTION OF THE DRAWINGS

FIG. 1 is a block diagram illustrating a known configuration of Voice over Internet Protocol (VoIP) telephony without the described apparatus, including a plurality of VoIP telephones and an associated computer system;

FIG. 2 is a block diagram illustrating a configuration of Voice over Internet Protocol (VoIP) telephony including a plurality of VoIP detecting apparatuses monitoring a plurality of VoIP telephones and an associated computer system;

FIG. 3 is a block diagram of a Voice over Internet Protocol (VoIP) detecting apparatus including inputs for the VoIP detecting apparatus, in a standard configuration;

FIG. 4 is an example diagram of a Voice over Internet Protocol (VoIP) detecting apparatus in a “passive tap” embodiment;

FIG. 5 is an example architectural diagram of a Voice over Internet Protocol (VoIP) detecting apparatus;

FIG. 6 is an example method for indicating active Voice over Internet Protocol (VoIP) sessions to a user using the apparatus of FIGS. 3, 4, and 5.

Although specific features of various embodiments may be shown in some drawings and not in others, this is for convenience only. Any feature of any drawing may be referenced and/or claimed in combination with any feature of any other drawing.

### DETAILED DESCRIPTION

As the popularity of VoIP communications has improved, internal and external threats to secure data networks has also increased. For example, VoIP deployment is currently available over WiFi when available, and cellular elsewhere. One VoIP call control standard is the Session Initiation Protocol (SIP). In addition to SIP-based desk phones, SIP-based soft-phones are being incorporated into personal computers (“PCs”), Laptops, personal data assistants (“PDAs”), and Smart-phones (IMS), for example. In voice networks, internal and external threats may have significantly amplified impacts because the telephone and its related services are personal, real-time, and interactive. All of these VoIP communications systems, and are vulnerable to inappropriate VoIP signaling and/or media streams that can attack an individual or an entire enterprise.

Current security management products for VoIP, although necessary and effective for what they do, cannot provide the needed functionality to stop such VoIP specific attacks. Due to security reasons, there is a concern in the marketplace that a VoIP device could become misused by an entity that gains access to the device through means of the network or through physical manipulation. Once access is gained, then the VoIP device can be inappropriately used to transport audio through the network without the knowledge of the user.

Disclosed herein are systems and, more specifically, a data appliance that is configured to detect or “sense” VoIP data packets communicated over a network. As described, VoIP data typically includes at least two data segments: (1) a first data segment created using a call control protocol and a (2) a second data segment created using a transport layer protocol. In many examples, the call control protocol may be SIP (Session Initiation Protocol) and the transport layer protocol may be RTP (Real-Time Protocol). Detailed descriptions of SIP and RTP protocols are available from documents such as those promulgated by the Network Working Group (NWG) including, for example, Request for Comment (“RFC”) 3550 RTP: A Transport Protocol for Real-Time Applications, RFC3551 RTP Profile for Audio and Video Conferences with Minimal Control, RFC3261 SIP: Session Initiation Protocol, RFC3262 Reliability of Provisional Responses in the Session Initiation Protocol (SIP), and RFC3263 Session Initiation Protocol (SIP): Locating SIP Servers.

As used herein, the systems and methods determine a packet type by parsing packets into data segments and identifying whether the packets include a data segment created based on a call control protocol (including, for example, SIP), and a data segment created based on a transport layer protocol (including, for example RTP).

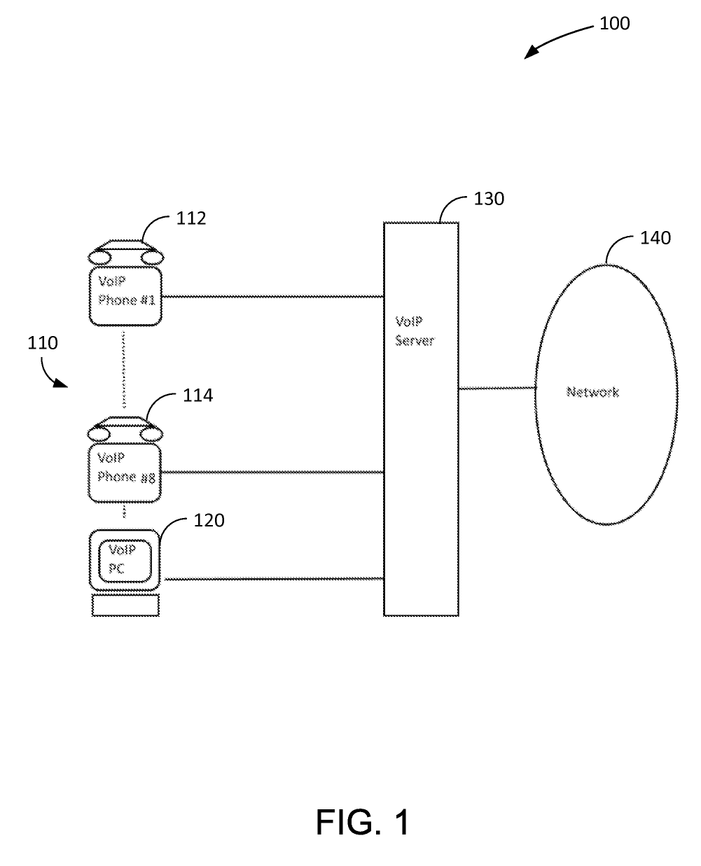

FIG. 1 is a block diagram illustrating a known configuration 100 of Voice over Internet Protocol (VoIP) telephony without the described apparatus. Configuration 100 includes a plurality of VoIP telephones 110 (including individual VoIP telephones 112 and 114) and an associated computer system 120. In configuration 100, a user may use VoIP telephones 110 (or, more specifically, first VoIP telephone 112 or second VoIP telephone 114) to communicate with another user inside or outside of network 140. Communications data for calls using VoIP telephones 110 may be routed through VoIP PC 120 which routes communications data to network 140. Alternately, communications data for communications using VoIP telephones 110 may be routed directly to VoIP server 130 which routes such communications data to or from network 140. In some examples, a user may directly use VoIP PC 120 for VoIP communication without using an additional VoIP telephone 110.

As is described above and herein, VoIP devices such as VoIP telephones 110 and VoIP PC 120 may be vulnerable to security attacks. In at least some examples, VoIP devices 110 and 120 may be misused through remote or direct access and inappropriately used to transport audio through network 140 without the knowledge of the user. As such, there exists a need for a system, method, and apparatus that provides security in VoIP communication systems (e.g., SIP, unified managed account (UMA), etc.) and that is capable of preventing the unauthorized use of the VoIP network, protecting the privacy of the VoIP users, and protecting the VoIP network infrastructure assets.

The apparatus, systems, and methods described herein substantially facilitate the effective monitoring of VoIP communications in order to prevent unauthorized use of the VoIP network. Specifically, the apparatus, systems, and methods described are configured to: (a) receive a plurality of packets sensed by a receiver, (b) determine a packet type for each of the plurality of packets sensed by the receiver, (c) determine the presence of VoIP traffic based on the determined packet types, and (d) activate the indicator based on the determination of the presence of VoIP traffic.

Notably, the apparatus, systems, and methods described herein are designed to address and solve a technical problem in computer networking. More specifically, the addressed technical problem may be categorized within the technical fields of network security and data protection.

While VoIP technology affords tremendous opportunities for scaling data and voice communications, it also has vulnerabilities that are unique to the context of VoIP networks. VoIP communications systems are vulnerable to inappropriate VoIP signaling and/or media streams that can attack an individual or an entire enterprise. As such, there is a risk that a VoIP device may be misused by an entity that gains access to the device through means of the network or through physical manipulation. Once access is gained, then the VoIP device can be inappropriately used to transport audio through the network without the knowledge of the user. Therefore, the use of VoIP technology is tied to a technical problem in computer networks of preventing such misuse of VoIP data by unauthorized entities. This technical problem is addressed by the apparatus, systems, methods, hardware, and software described herein, which are configured to mitigate the risk of such misused VoIP data.

As such, there exists a need for security in VoIP communication systems (e.g., SIP, unified managed account (UMA), etc.) that is capable of preventing the unauthorized use of the VoIP network, protecting the privacy of the VoIP users, and protecting the VoIP network infrastructure assets. The apparatus, systems, methods, hardware, and software described solve the technical problem by identifying VoIP data to facilitate remedial security steps. In some examples, the systems and methods described may use security services to secure VoIP traffic upon identifying that VoIP traffic is occurring. In some examples, upon detecting such VoIP traffic, the systems and methods are also configured to determine whether such VoIP traffic was previously identified as intended by a user. In further examples, the systems and methods are further configured to alert users (via an indicator or a user alert transmitted to a user device) upon detecting that VoIP traffic is occurring.

In order to protect a user from covert and overt VoIP transfer of audio, in the exemplary embodiment, a physical device is coupled between the VoIP device and the network. This device passively monitors the network traffic sent between the VoIP device and the network and monitors for VoIP traffic, in real-time. As used herein, VoIP traffic includes packets of RTP (Real-time Protocol) and SIP (Session Initiation Protocol). Moreover, as described herein, VoIP traffic may include packets of adhering to any call control protocol (including, for example, SIP) and packets adhering to any transport layer protocol (including, for example, RTP). Accordingly, packets including any standardized call control and any standardized transport layer protocol may be detected and analyzed by the device. When VoIP traffic is identified, the user is notified. Such notification can take the form of, but is not limited to a simple illumination indicator or audio alert. More sophisticated notifications can also be used, such as, but not limited to, covert signaling, text messages, and/or notification to a remote network security operator. Moreover, in the exemplary embodiment, the VoIP detection device can also store logs of all VoIP traffic with pertinent information concerning calls such as time, mac and IP address, phone numbers, etc. Operational mode settings can be set through the input interface including indication type, logging information, and/or alert triggers.

Normally, VoIP Phones or PCs used for VoIP communication are coupled directly to a network's cabling. When using the exemplary VoIP detecting apparatus described herein, the VoIP Device is disconnected from the network's cabling and is coupled to the VoIP detecting apparatus through a telecommunications connector such as an RJ-45 Jack labeled “VoIP device”. The network's cabling is then connected to the VoIP detecting apparatus through the RJ-45 Jack labeled “Network”.

Within the exemplary embodiment, the “VoIP device” is connected to a standard Ethernet jack and support components that interface the signals to an Ethernet controller then to a processor for determining the course of action. The same path is true for the “Network” connection jack. Within the exemplary embodiment, the “Network” is coupled to a standard Ethernet jack and support components that interface the signals to an Ethernet controller then to a processor for determining the course of action. Within the processor, packets sent from the Network to the VoIP device are analyzed for their packet type and retransmitted to the VoIP device. Likewise, Packets sent from the VoIP device to the Network are analyzed for their packet type and retransmitted to the Network.

The processor will filter through the packets and detect when an RTP or SIP packet is sent and analyze that packet for details to determine if an active session is in progress. If an active session is in progress than the processor will run an alerting program to indicate the presence of an active VoIP session.

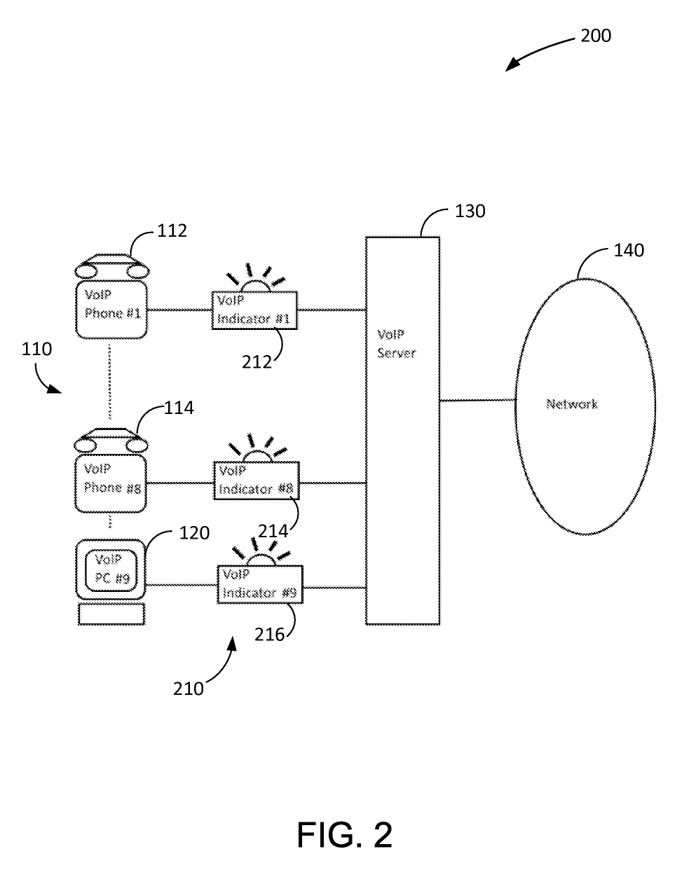

FIG. 2 is a block diagram illustrating a configuration 200 of Voice over Internet Protocol (VoIP) telephony including a plurality of VoIP detecting apparatuses 210 monitoring a plurality of VoIP telephones 110 and an associated computer system 120. As described in FIG. 1, users may use VoIP devices 110 (including individual VoIP telephones 112 and 114) and 120 to engage in VoIP telecommunications with users inside or outside of network 140.

In at least some examples, users may be interested to know whether VoIP communications are occurring using VoIP devices 110 and 120 when such users are not personally engaged in VoIP communications. More specifically, users may be interested to have an indication of whether VoIP data is being exchanged using VoIP devices 110 and 120 while such users are not intentionally acting in VoIP telecommunications (e.g., making a VoIP telephone call). In configuration 200, VoIP detecting apparatuses 212, 214, and 216 are communicatively coupled between VoIP devices 110, 112, 114, and 120 and VoIP server 130. Accordingly, all VoIP communications data routed between VoIP devices 110, 112, 114, and 120 and VoIP server 130 may be received by VoIP detecting apparatuses 212, 214, and 216 (collectively referred to as VoIP detecting apparatuses 210).

When using VoIP detecting apparatus 210 described herein, VoIP devices 110, 112, 114, and 120 are disconnected from network 150 and coupled to VoIP detecting apparatus 210 through a telecommunications connector such as an RJ-45 jack labeled “VoIP device”. Network cabling is then connected to VoIP detecting apparatus 210 through the RJ-45 Jack labeled “Network”.

As described herein, VoIP detecting apparatuses 212, 214, and 216 are configured to analyze data (and, more specifically, data packets) transmitted between VoIP devices 110, 112, 114, and 120 and VoIP server 130 in order to determine whether the data packets contain VoIP data. In an example embodiment, VoIP detecting apparatuses 210 analyze such data to identify packets in VoIP formats including RTP (Real-time Protocol) and SIP (Session Initiation Protocol). In alternative embodiments, VoIP detecting apparatuses 210 may analyze such data to identify packets in any other VoIP format. As described herein, data may be identified as containing VoIP packets by checking for packet layouts that conform to known VoIP packet structures and packet sizes that conform to known VoIP packet sizes. Upon identifying that one or more VoIP packets (e.g., SIP packets or RTP packets) have been passed through VoIP detecting apparatus 210, VoIP detecting apparatus 210 may determine the presence of VoIP traffic generally based on such packet transmission and activate an indicator, as described below. Activating the indicator may include triggering a visual indicator (e.g., a light emitting diode display), an audio indicator, or a data transmission (e.g., an alert sent via email, text message, or any other suitable medium) to a user at a user computing device.

In some examples, upon determining the presence of VoIP packets in a data transmission, VoIP detecting apparatus 210 may also store extracted information in a memory device (not shown in FIG. 2). In some examples, such data may be stored using encryption.

In an example embodiment, VoIP detecting apparatus 210 may also be configured to specifically identify the presence of VoIP data packets when such VoIP data packet transmission would not otherwise be intended. In one example, when users use VoIP telephones 110, 112, and 114, users will remove a handset from a cradle or otherwise disengage a handset from a standard location. In a second example, when users use VoIP telephones 110, 112, and 114, users will press a button to initiate or accept a VoIP telephone call. In a third example, when users use VoIP PC 120, users may actively transmit a request or accept a request for VoIP communication. In such examples, VoIP detecting apparatus 210 is configured to identify the presence of such “intended” communications and identify that an intended VoIP telecommunication is taking place. Accordingly, in such examples, VoIP detecting apparatus will determine the presence of an unintended VoIP data packet only when such indications of “intended” communications are not otherwise apparent.

In the example embodiment, VoIP detecting apparatus 210 is contained in a physical housing. The physical housing may be made of any suitable material and may include VoIP detecting apparatus 210, a receiver for capturing data (including VoIP data), an indicator for indicating the presence of VoIP packets, and a processing unit. In some examples, the indicator may be a visual indicator (e.g., a light emitting diode) while in other examples, the indicator may be an audio indicator (e.g., a device configured to emit an audible beep). In some examples, the visual indicator may be positioned within the physical housing of VoIP detecting apparatus 210 while remaining visible to a user viewing VoIP detecting apparatus 210. In further examples, the indicator may be configured to provide an indication of VoIP data packet transmission to a user device via a wired (e.g., local area network connection) or wireless connection (e.g., WiFi connection). In further examples, VoIP detecting apparatus 210 may include input and output features including a visual display (e.g., a touchscreen display or an LCD display) and an input interface (e.g., a keyboard or a touchscreen interface).

In some examples, VoIP detecting apparatus also includes a first physical connection configured to couple to VoIP devices 110, 112, 114, and 120 and a second physical connection configured to connect to VoIP network 140 and/or VoIP server 130.

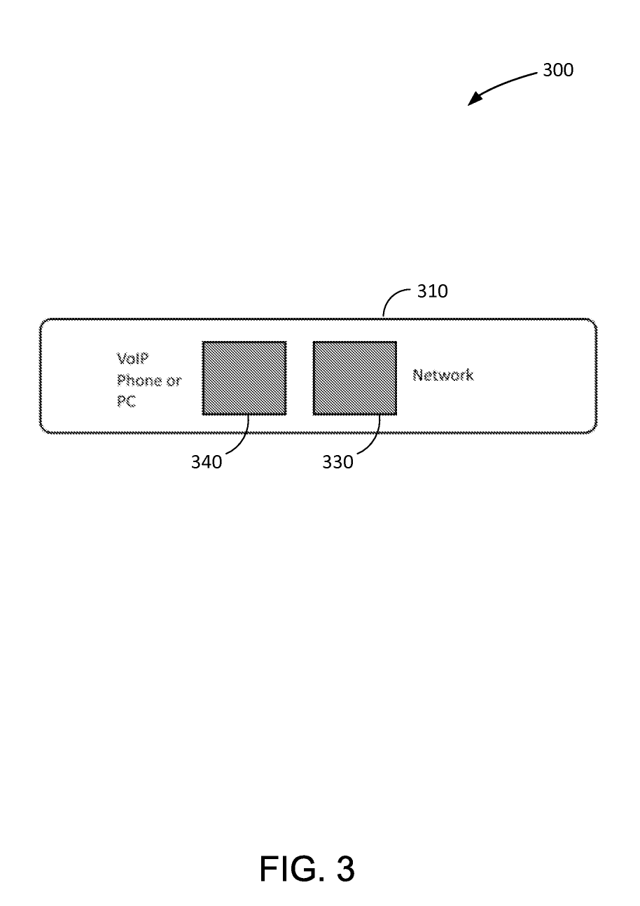

FIG. 3 is a block diagram 300 of a display of a Voice over Internet Protocol (VoIP) detecting apparatus 310 in a standard configuration. Diagram 300 illustrates an external view of VoIP detecting apparatus 310 indicating two inputs 330 and 340 for connecting to a VoIP Phone or PC. Accordingly, VoIP detecting apparatus 310 may connect to, for example, VoIP telephones 112 and 114 or VoIP PC 120 via input 340, and connect to VoIP server 130 and/or network 140 via input 330.

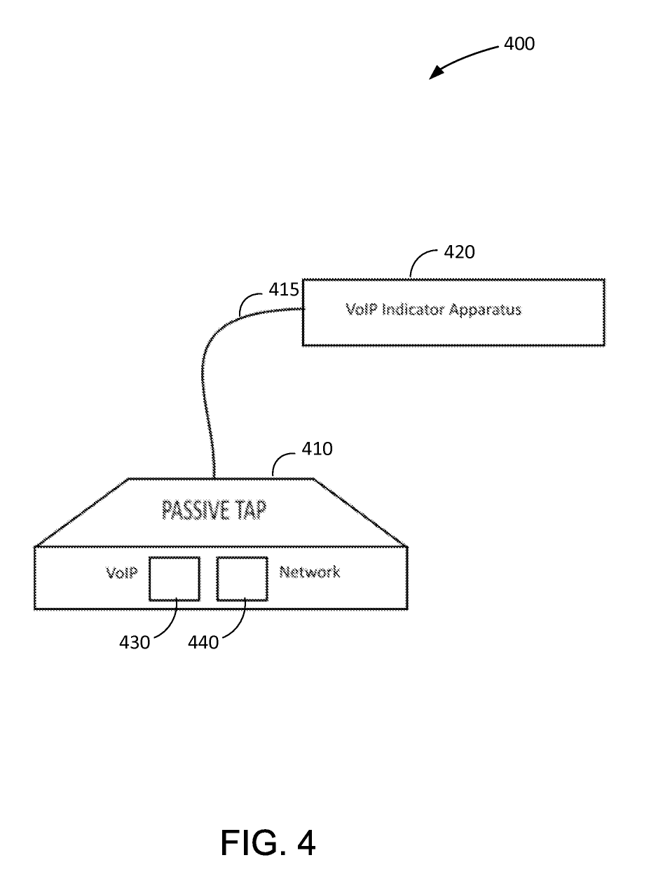

FIG. 4 is an example diagram 400 of a Voice over Internet Protocol (VoIP) detecting apparatus 420 in a “passive tap” embodiment. A passive tap interfaces the wiring between network 140 (and/or VoIP server 130) and VoIP devices 112, 114, and/or 120. A passive tap allows a direct tap (connection) to the wiring. The transceiver in this configuration must be set in promiscuous mode so that it does not affect the communication between the VoIP devices 112, 114, and/or 120 and network 140 (and/or VoIP server 130). “Promiscuous mode” makes the transceiver just a receiver and ensures that VoIP detecting apparatus taps and listens to the wiring between network 140 (and/or VoIP server 130) and VoIP devices 112, 114, and/or 120, but is not placed between VoIP devices 112, 114, and/or 120 and network 140 (and/or VoIP server 130).

Referring to FIGS. 3 and 4, VoIP detecting apparatus 420 embodiment differs from VoIP detecting apparatus 310. VoIP detecting apparatus 310 requires two transceivers in order to be an active bridge. VoIP detecting apparatus 310 uses, one transceiver connected to VoIP devices 112, 114, and/or 120 (via input 340) and a second transceiver connected to network 140 and/or VoIP server 130 via input 330. In VoIP detecting apparatus, packets sent from VoIP devices 112, 114, and/or 120 and destined to network 140 and/or VoIP server 130 are received by the first transceiver connected to VoIP devices 112, 114, and/or 120. The active bridge (not shown) communicates the received packet to the second transceiver and to network 140 and/or VoIP server 130 via input 330. The opposite process is used for packets destined for the VoIP devices 112, 114 and/or 120 and received from network 140 and/or VoIP server 130. Thus, in VoIP detecting apparatus 310, the apparatus is actually placed between VoIP devices 112, 114, and/or 120 and network 140 and/or VoIP server 130. The packets are analyzed between reception and retransmission (i.e., while the packets are carried across the active bridge). In contrast, in VoIP detecting apparatus 410, the apparatus is not between VoIP devices 112, 114, and/or 120 and network 140 and/or VoIP server 130.

In some embodiments, VoIP detecting apparatus 420 is in communication with a VoIP device 110, 112, 114, and 120 (shown in FIG. 1), and VoIP network 140 (shown in FIG. 1), through the use of a “passive tap” 410. In such embodiments, VoIP detecting apparatus 310 is in communication with the communication link between the VoIP device 110, 112, 114, and 120 and the VoIP network 140, and further in connection with devices 110, 112, 114, and 120, and network 140. Communication is facilitated by passive tap 410. VoIP devices 110, 112, 114, and 120 are connected to VoIP connector 430 of the passive tap 410. VoIP network 140 of the passive tap 410 is also connected to a network connector. Passive tap 410 exposes the connection to the VoIP detecting apparatus 410, which monitors the traffic with only the need for one receiver in promiscuous mode. In this embodiment, passive tap 410 creates a physical electrical connection between the VoIP Network 140, VoIP device 110, 112, 114, and 120, and the VoIP detecting apparatus 420.

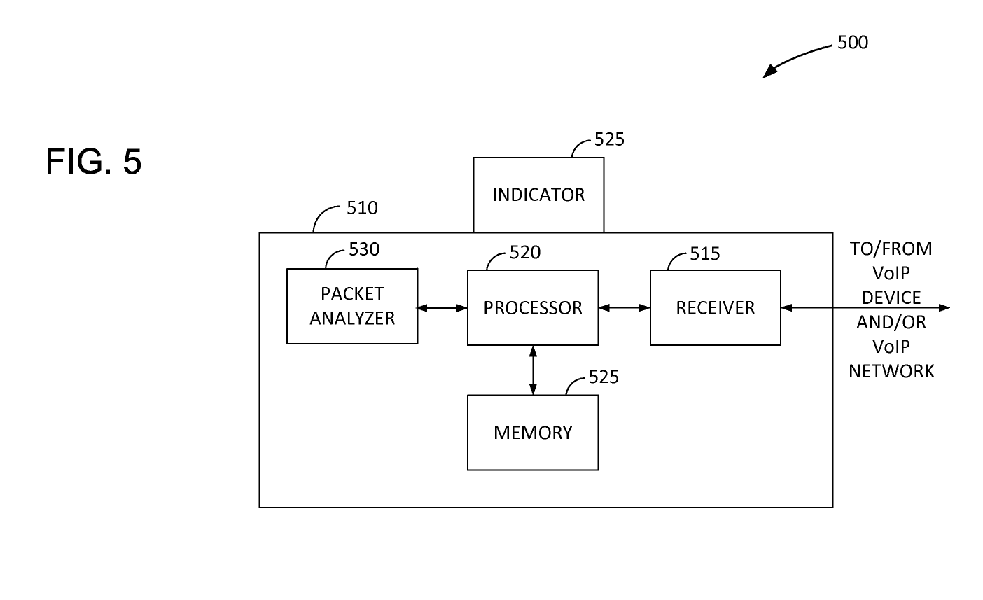

FIG. 5 is an example architectural diagram 500 of a Voice over Internet Protocol (VoIP) detecting apparatus 510. As described above and herein, VoIP detecting apparatus 510 includes a receiver capable of receiving information from VoIP devices 110, 112, 114, and 120 (shown in FIG. 1) and/or VoIP network 140 (shown in FIG. 1). VoIP detecting apparatus 510 also includes a processor 520 configured to process data and data packets received via receiver 515. VoIP detecting apparatus 510 also includes packet analyzer 530 configured to identify the presence of VoIP packets. In at least some examples, packet analyzer 530 is configured to determine that data received via receiver 515 includes at least one RTP or at least one SIP VoIP packet. Packet analyzer 530 may be included within processor 520 or may represent a separate device. In some examples, VoIP detecting apparatus 510 includes memory 525 for storing information such as VoIP identified data packets. VoIP detecting apparatus 510 also includes indicator 525. Indicator 525 may represent an audio indicator, a visual indicator, or a data indicator configured to communicate with external systems. As such, indicator 525 may be a light emitting diode display (or any suitable display), an audio speaker (or any suitable audio output), and a network device configured to communicate with a receiving user interested in alerts and indications from VoIP detecting apparatus 510.

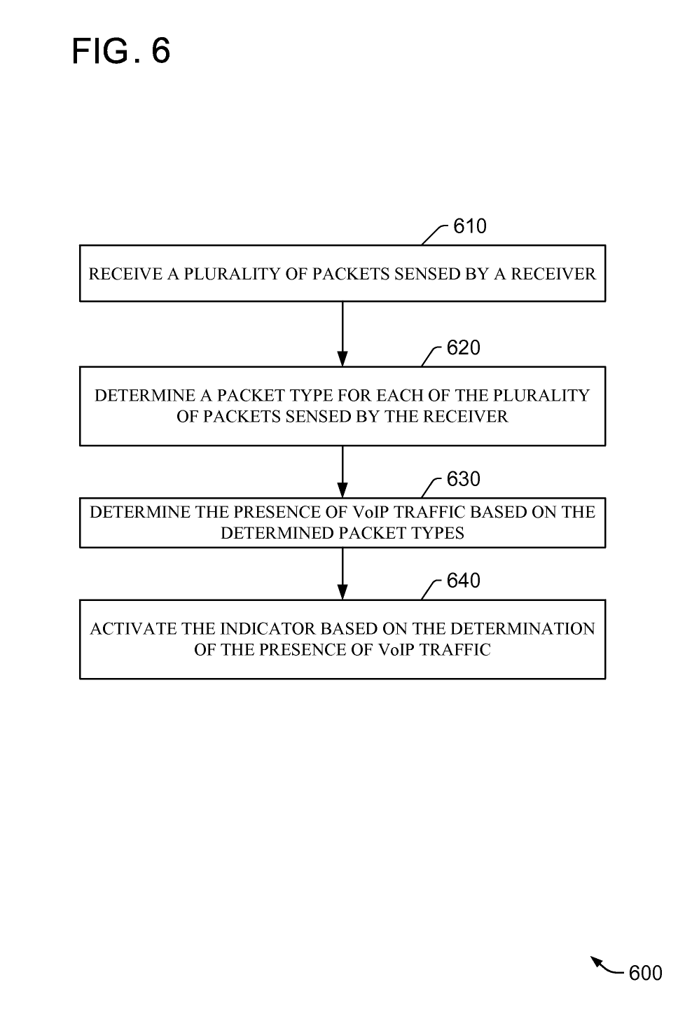

FIG. 6 is an example method for indicating active Voice over Internet Protocol (VoIP) sessions to a user using VoIP detecting apparatus 210 (shown in FIG. 2). As described above and herein, VoIP detecting apparatus 210 is configured to receive 610 a plurality of packets sensed by said receiver, determine 620 a packet type for each of the plurality of packets sensed by said receiver, determine 630 the presence of VoIP traffic based on the determined packet types, and activate 640 said indicator based on the determination of the presence of VoIP traffic.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

What is claimed is:

1. A Voice over Internet Protocol (VoIP) detecting apparatus for detecting unintended VoIP traffic between a VoIP device and a VoIP network, said apparatus comprising:
an interface configured to couple between said device and said VoIP network;
a receiver configured to sense packets on the VoIP network;
an indicator; and
a processor coupled to a memory device, said processor is programmed to:
receive a plurality of packets sensed by said receiver;
determine a packet type for each of the plurality of packets sensed by said receiver;
determine the presence of VoIP traffic based on the determined packet types; and
activate said indicator based on the determination of the presence of VoIP traffic.

2. The VoIP detecting apparatus of claim 1 further comprising a housing sized to contain said physical interface, said receiver, said indicator, and said processing unit therein.

3. The VoIP detecting apparatus of claim 1, wherein said interface comprises a first physical connection configured to couple to said VoIP device and a second physical connection configured to connect to the VoIP network.

4. The VoIP detecting apparatus of claim 1, wherein said physical interface further comprises an external passive tap device comprising a first connection configured to couple to said VoIP device, a second connection configured to couple to the VoIP network, and a third connection configured to couple to said apparatus.

5. The VoIP detecting apparatus of claim 1, wherein said indicator is an audio indicator.

6. The VoIP detecting apparatus of claim 2, wherein said indicator is a visual indicator positioned internal to said physical housing and oriented to be visible externally from said housing.

7. The VoIP detecting apparatus of claim 1, wherein said indicator is configured to transmit a signal via a wired connection to a user of said apparatus.

8. The VoIP detecting apparatus of claim 1, wherein when activated, said indicator is configured to wirelessly couple to a wirelessly-enabled device remote from said apparatus.

9. The VoIP detection apparatus of claim 9, wherein said input interface comprises at least one of a display and a touchscreen interface.

10. The VoIP detecting apparatus of claim 1, wherein said processor is further programmed to:
identify one or more transport layer packets in the plurality of packets sensed by said receiver; and
determine the presence of VoIP traffic based on the one or more transport layer packets.

11. The VoIP detecting apparatus of claim 10, wherein said processor is further programmed to:
extract information from the one or more transport layer packets; and
store the extracted information in said memory device.

12. The VoIP detecting apparatus of claim 1, wherein said processor is further programmed to:
identify one or more call control packets in the plurality of packets sensed by said receiver; and
determine the presence of VoIP traffic based on the one or more call control packets.

13. The VoIP detecting apparatus of claim 12, wherein said processor is further programmed to:
extract information from the one or more call control packets; and
store the extracted information in said memory device.

14. The VoIP detecting apparatus of claim 1, wherein said processor is further programmed to:
identify that said VoIP device is not actively engaged in an intentional VoIP telecommunication; and
determine the presence of VoIP traffic based on the determined packet types upon identifying that said VoIP device is not actively engaged in an intentional VoIP telecommunication.

15. A non-transitory computer readable medium for use in protecting one or more communications devices coupled to a VoIP network, said computer readable medium comprising program instructions when executed by a processor causes the processor to: receive a plurality of packets sensed by a receiver configured to sense packets on the network; determine a packet type for each of the plurality of packets sensed by the receiver; determine the presence of VoIP traffic based on the determined packet types; and alert a user based on the determination of the presence of VoIP traffic.

16. A system for protecting one or more communications devices, said system comprising:
a network communicatively coupled to the one or more communications devices; and
an apparatus for use in detecting when a VoIP communication session is actively established via said network, said apparatus comprising: an interface, a receiver, and a processor, said interface coupled between said apparatus and said network, said receiver configured to sense packets on said network, said processor programmed to receive a plurality of packets sensed by said receiver, determine a packet type for each of the plurality of packets sensed by said receiver, determine the presence of VoIP traffic based on the determined packet types, and provide an indication of the presence of VoIP traffic on said network.

17. The system of claim 16, wherein the apparatus is further configured to:
identify one or more transport layer packets in the plurality of packets sensed by said receiver; and
determine the presence of VoIP traffic based on the one or more transport layer packets.

18. The system of claim 17, wherein the apparatus is further configured to:
extract information from the one or more transport layer packets; and
store the extracted information in said memory device.

19. The system of claim 16, wherein the apparatus is further configured to:
identify one or more call control packets in the plurality of packets sensed by said receiver; and
determine the presence of VoIP traffic based on the one or more call control packets.

20. The system of claim 19, wherein the apparatus is further configured to:
extract information from the one or more call control packets; and
store the extracted information in said memory device.
